(19) United States
(12) Patent Application Publication
(10) Pub. No.: US 2026/0290888 A1
(43) Pub. Date: Sep. 24, 2026

(54) ORGANIC-INORGANIC COMPOSITE ELECTROLYTE MEMBRANE AND METHOD FOR MANUFACTURING SAME

(71) Applicant: UIF (UNIVERSITY INDUSTRY FOUNDATION), YONSEI UNIVERSITY, Seoul (KR)

(72) Inventors: Kyeong-Seok OH, Seoul (KR); Sang-Young LEE, Seoul (KR)

(73) Assignee: UIF (UNIVERSITY INDUSTRY FOUNDATION), YONSEI UNIVERSITY, Seoul (KR)

(21) Appl. No.: 19/476,075

(22) PCT Filed: Apr. 16, 2024
(86) PCT No.: PCT/KR2024/005068

§ 371 Date: Oct. 16, 2025

(30) Foreign Application Priority Data
Apr. 19, 2023 (KR) 10-2023-0051575

(51) Int. Cl. H01M 10/0562

(52) U.S. Cl. CPC H01M 10/0562; H01M 2300/0068; H01M 2300/0082; H01M 2300/0088

(57) ABSTRACT

The present invention relates to an organic-inorganic composite electrolyte membrane and a method for manufacturing the same, wherein the organic-inorganic composite electrolyte membrane according to one aspect overcomes the disadvantages of the conventional sulfide-based solid electrolyte, which had problems such as difficulty in manufacturing a thin film due to brittleness and lack of flexibility, and can secure flexibility while simultaneously exhibiting excellent ion conductivity.

### CROSS-REFERENCE TO RELATED APPLICATIONS

This application is a § 371 national stage entry of International Application No. PCT/KR2024/005068, filed on Apr. 16, 2024, which claims priority to Korean Patent Application No. 10-2023-0051575, filed on Apr. 19, 2023, the entire contents of which are incorporated herein by reference.

### BACKGROUND

### 1. Field

The present invention relates to an organic-inorganic composite electrolyte membrane and a method for manufacturing the same.

### 2. Description of Related Art

Recently, as the development of lithium batteries with improved energy density and safety has been required, all-solid-state batteries using solid electrolytes instead of liquid electrolytes are drawing attention as next-generation batteries.

Solid electrolytes can be classified into polymer organic solid electrolytes or inorganic solid electrolytes depending on their material, and in particular, inorganic solid electrolytes have the advantage of being able to secure a high cation transport number and ion conductivity.

In particular, sulfide-based solid electrolytes, which are one type of inorganic solid electrolyte, exhibit very high ion conductivity of about 10⁻² to 10⁻⁴ S/cm and excellent electrochemical stability, but due to the inherent stiffness and brittleness of the solid electrolyte, it is very difficult to manufacture them into a thin film, and their flexibility is very poor, leading to difficulties in commercialization.

Furthermore, sulfide-based solid electrolytes have high moisture reactivity when exposed to the atmosphere, forming H₂S, which leads to poor stability in the air, and because the electrolyte is solid, it has a high interfacial resistance with the electrode. In addition, an unstable interface is present in the contact between the cathode active material and the sulfide solid electrolyte, and problems such as stability deterioration, such as dendrite growth through voids, exist due to grain boundary defects between the electrolyte particles.

On the other hand, polymer solid electrolytes have superior advantages over inorganic solid electrolytes in terms of flexibility, lightness, and processability. However, polymer solid electrolytes have problems such as insufficient ion conductivity and lithium ion transport number at room temperature compared to conventional liquid electrolytes and inorganic solid electrolytes, and difficulties in combination with high-voltage cathode materials due to a low electrochemical window.

Therefore, in order to solve the above problems, there is an urgent need for research on solid electrolytes that can secure flexibility while maintaining the ion conductivity of the sulfide-based solid electrolyte and have improved interfacial stability.

### SUMMARY

To solve the above problems, the present invention aims to provide an organic-inorganic composite electrolyte membrane that includes a sulfide-based solid electrolyte and has excellent flexibility and outstanding ion conductivity.

Another object of the present invention is to provide an all-solid-state battery including the organic-inorganic composite electrolyte membrane.

In order to achieve the above-mentioned object, the present inventors have continuously researched to manufacture a solid electrolyte that can secure flexibility while maintaining the ion conductivity of the sulfide-based solid electrolyte and has improved interfacial stability. As a result, they found that when an organic-inorganic composite electrolyte including a sulfide-based solid electrolyte, a cross-linked polymer matrix, an ionic liquid, and a lithium salt is integrated with a porous support having a specific pore size, a thin and large-area electrolyte membrane can be manufactured, and it has excellent flexibility and outstanding ion conductivity, thereby completing the present invention.

The present invention includes a porous support and an organic-inorganic composite electrolyte, wherein the organic-inorganic composite electrolyte includes a sulfide-based solid electrolyte, a cross-linked polymer matrix, an ionic liquid, and a lithium salt, and the organic-inorganic composite electrolyte is integrated with the porous support, characterized by providing an organic-inorganic composite electrolyte membrane.

According to one embodiment of the present invention, the ionic liquid may include a glyme-based solvent.

According to one embodiment of the present invention, the molar ratio of the ionic liquid to the lithium salt may satisfy 0.5 to 1.5:1.

According to one embodiment of the present invention, the cross-linked polymer matrix may be derived from a polyfunctional monomer.

According to one embodiment of the present invention, the polyfunctional monomer may be a monomer containing two or more photocurable functional groups selected from the group consisting of an acrylate group, a methacrylate group, a vinyl group, and a thiol group, or a combination of one or more thereof.

According to one embodiment of the present invention, the weight ratio of the cross-linked polymer matrix to the sum of the ionic liquid and the lithium salt may satisfy 3 to 15:85 to 97.

According to one embodiment of the present invention, the cross-linked polymer matrix may be included in an amount of 0.5 to 10 parts by weight based on 100 parts by weight of the sulfide-based solid electrolyte.

According to one embodiment of the present invention, the porous support has an average pore size of 50 μm or more.

According to one embodiment of the present invention, the porous support may have a thickness of 5 to 40 μm.

According to one embodiment of the present invention, the organic-inorganic composite electrolyte membrane may have a thickness of 10 to 40 μm.

According to one embodiment of the present invention, the organic-inorganic composite electrolyte membrane may have an ion conductivity of 3.0×10⁻⁴ S/cm or more.

According to one embodiment of the present invention, the organic-inorganic composite electrolyte membrane may have an ion conductivity retention rate of 90% or more after 100 cycles of the 180° bending test.

According to one embodiment of the present invention, the organic-inorganic composite electrolyte membrane may have a structure in which two or more layers are stacked in the thickness direction.

The present invention may provide a method for manufacturing an organic-inorganic composite electrolyte membrane, including a step of manufacturing an organic-inorganic composite electrolyte by coating and polymerizing a slurry composition including a sulfide-based solid electrolyte, a polyfunctional monomer, an ionic liquid, and a lithium salt on a porous support.

According to one embodiment of the present invention, the ionic liquid may include a glyme-based solvent.

According to one embodiment of the present invention, the slurry composition may substantially not include a solvent.

According to one embodiment of the present invention, the method may further include a step of pressing the organic-inorganic composite electrolyte membrane.

The organic-inorganic composite electrolyte membrane according to one aspect of the present invention overcomes the disadvantages of the conventional sulfide-based solid electrolyte, which had problems such as difficulty in manufacturing a thin film due to brittleness and lack of flexibility, and can secure flexibility while simultaneously exhibiting excellent ion conductivity.

### BRIEF DESCRIPTION OF THE DRAWINGS

FIG. 1 is a schematic diagram of an organic-inorganic composite electrolyte membrane according to one embodiment.

FIG. 2 is a photograph showing the process of the 180° bending test of Evaluation Example 1.

FIG. 3 is a Nyquist plot before and after 100 cycles of the 180° bending test for the organic-inorganic composite electrolyte membrane according to Example 1.

FIG. 4 is the 7Li MAS NMR spectrum of the organic-inorganic composite electrolyte membranes according to Examples 1 and 2.

FIG. 5 is a graph analyzing the electrochemical characteristics (charge/discharge voltage profile) of the lithium metal battery, which includes the organic-inorganic composite electrolyte membranes according to Examples 1 and 2. In FIG. 5, the falling curve is the initial discharge capacity, and the rising curve represents the initial charge capacity.

FIG. 6 is a result graph analyzing the life characteristics (change in capacity and Coulombic efficiency according to the number of charge/discharge cycles) of the lithium metal battery including the organic-inorganic composite electrolyte membranes according to Examples 1 and 2.

FIG. 7 is a result graph analyzing the rate characteristics (change in capacity according to the number of charge/discharge cycles by current density) of the lithium metal battery including the organic-inorganic composite electrolyte membranes according to Examples 1 and 2.

### DETAILED DESCRIPTION

Unless otherwise defined herein, all technical and scientific terms have the same meaning as commonly understood by one of ordinary skill in the art to which this invention belongs. The terms used in the description herein are for the purpose of effectively describing particular embodiments only and are not intended to limit the invention.

The singular forms used herein may be intended to include the plural forms as well, unless the context clearly dictates otherwise.

Further, numerical ranges used in this specification include all values within the lower and upper limits and the range thereof, logically derived increments in the form and width of the defined range, all doubly limited values, and all possible combinations of the upper and lower limits of numerical ranges defined in different forms. Unless otherwise defined in this specification, values outside the numerical range that may occur due to experimental error or rounding of values are also included in the defined numerical range.

The term “comprising” as used herein, is an open-ended term having an equivalent meaning to expressions such as “having”, “containing”, “possessing”, or “characterized by” and does not exclude elements, materials, or processes not additionally enumerated.

Further, when a certain layer is positioned “on” another layer in the present invention, this includes not only the case where a certain layer is directly contacting the other layer, but also the case where one or more other layers exist between the two layers.

Hereinafter, the organic-inorganic composite electrolyte membrane according to one embodiment of the present invention will be described in more detail.

The present invention provides an organic-inorganic composite electrolyte membrane including a porous support and an organic-inorganic composite electrolyte, wherein the organic-inorganic composite electrolyte includes a sulfide-based solid electrolyte, a cross-linked polymer matrix, an ionic liquid, and a lithium salt, and the organic-inorganic composite electrolyte is integrated with the porous support.

According to one embodiment of the present invention, the sulfide-based solid electrolyte may be a conventional sulfide-based solid electrolyte used in the relevant technical field, and specifically, it may be represented by MₐPN_{b}S_{c}X_{d}. Herein, Mis Li, Na, or a combination thereof, Nis B, Al, Ga, In, Si, Ge, Sn, Pb, Sb, Bi, Ti, V, Cr, Mn, Fe, Co, Ni, Cu, Y, Zr, Nb, Mo, Tc, Ru, Rh, Pd, Ag, Hf, Ta, W, X: F, Cl, Br, I, or a combination thereof; X is O, Se, Te or a combination thereof; and 0≤a≤6, 0≤b≤6, 0≤c≤6, and 0≤d≤6.

Specifically, the sulfide-based solid electrolyte may be represented by Li₂S—P₂S₅-MY_{f}. Herein, the Y may be O, S, Se, Te, or a combination thereof, and 0.50≤f≤4.

Alternatively, the sulfide-based solid electrolyte may be represented by MₐPS_{c}X_{d}. Herein, Mis Li, Na, or a combination thereof; Nis B, Al, Ga, In, Si, Ge, Sn, Pb, Sb, Bi, Ti, V, Cr, Mn, Fe, Co, Ni, Cu, Y, Zr, Nb, Mo, Tc, Ru, Rh, Pd, Ag, Hf, Ta, W, or a combination thereof; X is F, Cl, Br or I; and 0≤a≤6, 0≤b≤6, 0≤c≤6, and 0≤d≤6.

Specifically, the sulfide-based solid electrolyte may use LPSCl.

The sulfide-based solid electrolyte may be amorphous or crystalline, and the average particle size may be 50 nm to 50 μm, or 100 nm to 10 μm, but is not limited thereto. The sulfide-based solid electrolyte may be included in an amount of 30 wt % or more, 40 to 80 wt %, or 50 wt % or more, 50 to 80 wt %, 55 wt % or more, or 55 to 80 wt %.

According to one embodiment of the present invention, the ionic liquid may include a glyme-based solvent. As a non-limiting example, the glyme-based solvent may be 1,2-dimethoxymethane, 1,2-dimethoxyethane (DME), diethyleneglycol dimethyl ether (diglyme), diethylene glycol diethyl ether, triethylene glycol dimethyl ether, triethylene glycol diethyl ether, tetraethylene glycol dimethyl ether (TEGDME, tetraglyme), tetrahydrofuran (THF), 2-methyl tetrahydrofuran, dimethyl ether and dibutyl ether, or a combination of one or more thereof.

According to one embodiment of the present invention, the lithium salt may be a combination of a lithium metal; and one or more anions selected from the group consisting of bis(fluorosulfonyl)imide (FSI), bis(trifluoromethylsulfonyl)imide (TFSI), bis(pentafluoroethylsulfonyl)imide (PFSI), and hexafluorophosphate (PF₆⁻). For example, the lithium salt may be LiFSI, LiTFSI, or LiPFSI.

According to one embodiment of the present invention, the molar ratio of the ionic liquid to the lithium salt may satisfy 0.1 to 5:1, or 0.5 to 1.5:1, or 0.8 to 1.2:1.

When the ionic liquid and the lithium salt are mixed in the organic-inorganic composite electrolyte, the lithium metal of the lithium salt may coordinate to the oxygen of the ionic liquid, and the anion of the lithium salt may form a solvated ionic liquid present around it. The solvated ionic liquid may be included in the organic-inorganic composite electrolyte according to one embodiment, thereby further improving the ion conductivity of the organic-inorganic composite electrolyte.

According to one embodiment of the present invention, the cross-linked polymer matrix may be derived from a polyfunctional monomer. Specifically, the cross-linked polymer matrix may be a cross-linked polymer having a three-dimensional cross-linked structure prepared by thermal polymerization or photopolymerization of a polyfunctional monomer. The polyfunctional monomer may be a monomer containing two or three or more reactive functional groups selected from the group consisting of an acryl group, a methacryl group, a vinyl group, a thiol group, an epoxy group, an isocyanate group, a silanol group, a halogen, a carboxyl group, a hydroxyl group, and an amine group. Further, the weight of the cross-linked polymer matrix may be the same as the weight of the polyfunctional monomer input during manufacturing.

Specifically, the polyfunctional monomer may be a monomer containing two or more photocurable functional groups selected from the group consisting of an acrylate group, a methacrylate group, a vinyl group, and a thiol group, or two or more thereof. Further, the number average molecular weight of the polyfunctional monomer may be 100 to 2,000 g/mol, specifically 100 to 1,000 g/mol.

As non-limiting examples, the polyfunctional monomer may include diglycidyl ether, trimethylolpropane triglycidyl ether, pentaerythritol polyglycidyl ether, benzyl glycidyl ether, triglycidyl isocyanurate, polyglycidyl ether, ethoxylated trimethylolpropane triacrylate (ETPTA), trimethylolpropane propoxylate triacrylate (TPPTA), pentaerythritol triacrylate (PETA), trimethylolpropane tris(3-mercaptopropionate (TMPT), trimethylolpropane triacrylate (TMPTA), pentaerythritol tetrakis(3-mercaptopropionate) (PEMP), and dipentaerythritol hexakis (3-mercaptopropionate), but is not limited thereto.

According to one embodiment of the present invention, the polyfunctional monomer may be a polyalkylene oxide-based polyfunctional monomer. Non-limiting examples of the polyalkylene oxide-based polyfunctional monomer include diethylene glycol diacrylate, diethylene glycol dimethacrylate, ethylene glycol dimethacrylate, dipropylene glycol diacrylate, dipropylene glycol dimethacrylate, ethylene glycol divinyl ether, ethoxylated trimethylolpropane triacrylate, diethylene glycol divinyl ether, triethylene glycol dimethacrylate, tetraethylene glycol diacrylate, polyethylene glycol diacrylate (PEGDA), and polyethylene glycol dimethacrylate, and specifically, polyethylene glycol diacrylate (PEGDA), polyethylene glycol dimethacrylate, or a mixture thereof may be used, but is not limited thereto.

According to one embodiment of the present invention, the cross-linked polymer matrix may be included in an amount of 0.1 to 40 parts by weight, or 0.5 to 10 parts by weight, or 1 to 7 parts by weight based on 100 parts by weight of the sulfide-based solid electrolyte.

According to one embodiment of the present invention, the weight ratio of the cross-linked polymer matrix to the sum of the ionic liquid and the lithium salt may satisfy 1 to 30:70 to 99, or 3 to 15:85 to 97, or 5 to 12:88 to 95.

According to one embodiment of the present invention, the mixture including the cross-linked polymer matrix, the ionic liquid, and the lithium salt, excluding the sulfide-based solid electrolyte, in the organic-inorganic composite electrolyte may be referred to as a gel polymer electrolyte, and the Young's modulus measured according to ASTM D882 for a 70 μm thick film including only the gel polymer electrolyte may be 300 MPa or less, preferably 200 MPa or less, or 1 to 200 MPa, preferably 1 to 150 MPa, or 5 to 150 MPa, or 5 to 100 MPa, or 5 to 60 MPa, or 5 to 40 MPa. When the Young's modulus is satisfied, the connectivity between the inorganic particles is not hindered, and thus more excellent ion conductivity can be exhibited.

According to one embodiment of the present invention, the porous support may be used without significant limitation if the organic-inorganic composite electrolyte is integrated to form an organic-inorganic composite electrolyte membrane. For example, polyester, polyamide (aromatic, aliphatic, etc., ex. Kevlar), cellulose, polysulfone, polyethersulfone, polyimide, polyamideimide, polytetrafluoroethylene, polyethylene, polypropylene, polyvinylidene fluoride, polyethylene terephthalate, and polyacrylonitrile may be used.

According to one embodiment of the present invention, the porous support may have an average pore size of 50 μm or more, or 50 to 150 μm, or 55 to 110 μm, or 60 to 90 μm. In the case of the organic-inorganic composite electrolyte membrane using a porous support having the pore size, the organic-inorganic composite electrolyte is effectively integrated with the porous support, thereby imparting flexibility and simultaneously having excellent ion conductivity. Further, if the average pore size is outside the range, insufficient ion conductivity may be exhibited.

According to one embodiment of the present invention, the porous support may have a porosity of 10 to 99%, or 30 to 95%, or 60 to 95%, or 70 to 90%, or 80 to 90%. By using a porous support satisfying the porosity, an organic-inorganic composite electrolyte membrane capable of simultaneously achieving more excellent flexibility and high ion conductivity can be manufactured. Further, a porous support having excessively low porosity may exhibit insufficient ion conductivity.

According to one embodiment of the present invention, the porous support may have a thickness of 5 to 100 μm, or 5 to 40 μm, or 10 to 30 μm, but is not limited thereto.

According to one embodiment of the present invention, when the porous support has a thickness of 10±2 μm, the weight per unit area may be 0.05 to 2 mg/cm², or 0.1 to 1 mg/cm².

According to one embodiment of the present invention, the organic-inorganic composite electrolyte is characterized by being integrated with the porous support. Specifically, the organic-inorganic composite electrolyte may be integrated with the porous support in the entire volume, or the organic-inorganic composite electrolyte may be integrated with the porous support in a part thereof, thereby forming an organic-inorganic composite electrolyte layer consisting of (a) a part integrated with the porous support and (b) the organic-inorganic composite electrolyte only existing on the porous support.

According to one embodiment of the present invention, the organic-inorganic composite electrolyte membrane may have a thickness of 5 to 100 μm, or 10 to 60 μm, or 10 to 50 μm, or 10 to 40 μm, but it may be easily adjusted depending on the intended use or physical properties.

According to one embodiment of the present invention, the organic-inorganic composite electrolyte membrane may have a structure in which two or more unit electrolyte membranes are stacked in the thickness direction. By repeatedly stacking the unit electrolyte membranes, a flexible organic-inorganic composite electrolyte membrane having excellent ion conductivity can be manufactured. The unit electrolyte membrane may have a stacked structure of 2, 3, 4, 5, 6, 7, 8, 9, 10 or more, or 2 to 15, or 4 to 12 in the thickness direction, but is not limited thereto and can be easily adjusted according to the physical properties to be manufactured.

According to one embodiment of the present invention, the organic-inorganic composite electrolyte membrane may have an ion conductivity of 1.0×10⁻⁴ S/cm or more, or 3.0×10⁻⁴ S/cm or more, or 3.5×10⁻⁴ S/cm or more.

According to one embodiment of the present invention, the ion conductivity measured after 100 cycles of the 180° bending test for the organic-inorganic composite electrolyte membrane may maintain 80% or more, 90% or more, preferably 95% or more, or 99% or more relative to the initially measured ion conductivity.

Hereinafter, the method for manufacturing the organic-inorganic composite electrolyte membrane according to one embodiment will be described in more detail.

The present invention may provide a method for manufacturing an organic-inorganic composite electrolyte membrane, including a step of manufacturing an organic-inorganic composite electrolyte by coating and polymerizing a slurry composition including a sulfide-based solid electrolyte, a polyfunctional monomer, an ionic liquid, and a lithium salt on a porous support. Herein, detailed descriptions and examples of compounds for the sulfide-based solid electrolyte, the polyfunctional monomer, the ionic liquid, and the lithium salt are the same as described above, and thus are omitted.

According to one embodiment of the present invention, in the slurry composition, the polyfunctional monomer may be included in an amount of 0.1 to 40 parts by weight, or 0.5 to 10 parts by weight, or 1 to 7 parts by weight based on 100 parts by weight of the sulfide-based solid electrolyte.

In particular, in the present invention, when the content of the polyfunctional monomer is outside the range of 0.5 to 10 parts by weight, the continuous phase of the sulfide-based solid electrolyte may not be formed, and thus, the ion conductivity may not be maximized depending on the cell implementation condition.

Further, the weight ratio of the polyfunctional monomer to the sum of the ionic liquid and the lithium salt may satisfy 1 to 30:70 to 99, or 3 to 15:85 to 97, or 5 to 12:88 to 95.

In addition, the slurry composition may further include a known polymerization initiator widely used in the technical field. The polymerization initiator may be a thermal initiator or a photoinitiator. Non-limiting examples of the thermal initiator include azo-based initiators such as 2,2-azobis-2,4-dimethylvaleronitrile, 2,2-azobisisobutyronitrile, and 2,2-azobis-2-methylbutyronitrile; or peroxide-based initiators such as amyl peroxy pivalate, hexyl peroxy dicarbonate, benzoyl peroxide, and dibenzoyl peroxide. The photoinitiator may be used without significant limitation as long as it is a compound capable of generating radicals by irradiation of active energy rays and initiating a radical reaction. Non-limiting examples include alpha-ketone compounds, acetophenone compounds, ketal compounds, aromatic sulfonyl chloride compounds, photoactive oxime compounds, benzophenone compounds, thioxanthone compounds, camphoroquinone compounds, halogenated ketone compounds, acylphosphine oxide compounds, and acylphosphonate compounds.

According to one embodiment of the present invention, the slurry composition may substantially not include a solvent. Herein, the meaning of “substantially not including” may mean including the solvent in an amount of 1 wt % or less, specifically 0.1 wt % or less, based on the total weight of the slurry composition. The method for manufacturing the organic-inorganic composite electrolyte membrane according to one embodiment is characterized by desolvation without using a separate solvent in the process. In conventional process technologies that used solvents, there were great difficulties in selecting a solvent due to the high chemical reactivity of sulfides, and there was also a problem that the solvents used were highly toxic, resulting in excessive treatment costs. However, the manufacturing method according to one embodiment is a solvent-free process, which has the advantage that the electrolyte and the sulfide are non-reactive and no separate solvent treatment cost occurs. Furthermore, since the organic-inorganic composite electrolyte membrane is a continuous phase exhibiting lithium ion conductivity, depending on the combination of the inorganic particles, which are the sulfide-based solid electrolyte, and the cross-linked polymer matrix, thinning is possible, high flexibility is exhibited, and above all, the effect of improving the continuous phase between the inorganic particles, which are the passage of lithium ions, can be realized, thereby exhibiting ion conductivity and battery characteristics far superior to those of the conventional technology, the independent sulfide-based solid electrolyte, or the cross-linked polymer matrix.

According to one embodiment of the present invention, the method of coating the slurry composition may use conventionally used or known application or coating methods, for example, coating methods selected from knife casting, tape casting, doctor blade coating, bar coating, spin coating, slot die coating, dip coating, and spray coating; or printing methods selected from inkjet printing, gravure printing, gravure offset, aerosol printing, stencil printing, and screen printing, but is not limited thereto. Preferably, tape casting may be used.

According to one embodiment of the present invention, the method for curing the slurry composition may use conventionally used or known thermal polymerization or photocuring methods. The thermal curing may be heating at a temperature of 60° C., preferably 80° C. or more, for a certain period of time. Further, the photocuring may be curing by irradiating a light source in the ultraviolet (UV) wavelength region, for example, irradiating the substrate with a lamp in the ultraviolet (UV) wavelength region of 254 nm, 300 nm, 365 nm, 385 nm, 395 nm or a 1260 mW/cm² Hg UV lamp, but is not limited thereto. Through this, the polyfunctional monomer is polymerized to form a cross-linked polymer matrix, which functions as a binder, thereby suppressing the detachment of the sulfide-based solid electrolyte and manufacturing an organic-inorganic composite electrolyte membrane with excellent durability.

According to one embodiment of the present invention, the organic-inorganic composite electrolyte membrane manufactured through a unit process including the above manufacturing step one time each is defined as a unit electrolyte membrane, and an organic-inorganic composite electrolyte membrane having a plurality of unit electrolyte membranes can be manufactured by performing the unit process multiple times.

The organic-inorganic composite electrolyte membrane manufactured through the process is defined as a unit electrolyte membrane, and an organic-inorganic composite electrolyte membrane having a plurality of unit electrolyte membranes can be manufactured by performing the unit process multiple times. Specifically, the method may further include the step of repeatedly performing the manufacturing step one or more times, 1 time, 2 times, 3 times, 4 times, 5 times, or 5 or more times on the unit electrolyte membrane. Through this, an organic-inorganic composite electrolyte membrane with excellent ion conductivity and flexibility, having a plurality of the unit electrolyte membranes formed and effectively suppressing the detachment of the sulfide-based solid electrolyte, can be manufactured.

According to one embodiment of the present invention, the method may further include a step of pressing the organic-inorganic composite electrolyte membrane. The pressing method may use conventionally used or known methods, for example, applying a pressure of 1 MPa or more, preferably 3 to 10 MPa or 3 to 500 MPa, for a certain period of time at room temperature or a temperature of 60° C., or 80° C. or more, or may be performed using a conventional roll press or hydraulic press. Through this, an organic-inorganic composite electrolyte membrane having higher adhesion can be manufactured.

Hereinafter, an all-solid-state battery according to one aspect will be described, but except for including the organic-inorganic composite electrolyte membrane according to one aspect, it can be manufactured in a structure known in the art using conventional manufacturing methods and materials in the technical field.

The present invention may provide an all-solid-state battery including the organic-inorganic composite electrolyte membrane described above. The all-solid-state battery includes a cathode layer and an anode layer, includes an organic-inorganic composite electrolyte layer between the cathode layer and the anode layer, and the organic-inorganic composite electrolyte layer may include the organic-inorganic composite electrolyte membrane according to one aspect.

According to one embodiment of the present invention, the cathode layer may include a cathode current collector and a cathode active material layer formed on the cathode current collector.

According to another embodiment of the present invention, the cathode active material layer is impregnated with the organic-inorganic composite electrolyte according to one aspect in the pores, and the cathode layer and the organic-inorganic composite electrolyte layer may be integrated with each other.

For example, the thickness of the organic-inorganic composite electrolyte layer may be 0.1 to 100 μm, 1 to 100 μm, or 5 to 40 μm, wherein the thickness of the organic-inorganic composite electrolyte layer means the thickness of the section where the cathode active material layer and the organic-inorganic composite electrolyte do not coexist and only the organic-inorganic composite electrolyte membrane according to one aspect exists.

The all-solid-state battery according to one aspect may be manufactured by including the steps of: (A) coating a cathode slurry composition on one surface of a cathode current collector, followed by drying and rolling to manufacture a porous cathode active material layer; (B) impregnating the cathode active material layer with the slurry composition according to one aspect and polymerizing to manufacture a cathode layer impregnated with the organic-inorganic composite electrolyte and an organic-inorganic composite electrolyte layer integrated with the cathode layer; and (C) stacking the cathode layer impregnated with the organic-inorganic composite electrolyte and an anode layer.

Non-limiting examples of the cathode current collector may include foils manufactured by aluminum, nickel, or a combination thereof, and the cathode slurry composition may include a solvent, and optionally a binder, a conductive agent, and a dispersant, in the cathode active material. The thickness of the cathode current collector is not particularly limited, but may be 3 to 500 μm.

The cathode active material, if it is a material capable of reversible insertion and extraction of lithium ions, may use conventional cathode active materials used in this technical field without limitation, and non-limiting examples include lithium cobalt oxide composite oxide (LiCoO₂), spinel crystalline lithium manganese oxide composite oxide (LiMn₂O₄), lithium manganese oxide composite oxide (LiMnO₂), lithium nickel oxide composite oxide (LiNiO₂), lithium iron phosphate (LiFePO₄), lithium manganese phosphate (LiMnPO₄), lithium cobalt phosphate (LiCoPO₄), lithium iron pyrophosphate (Li₂FeP₂O₇), lithium niobium oxide composite oxide (LiNbO₂), lithium iron oxide composite oxide (LiFeO₂), lithium magnesium oxide composite oxide (LiMgO₂), lithium copper oxide composite oxide (LiCuO₂), lithium zinc oxide composite oxide (LiZnO₂), lithium molybdenum oxide composite oxide (LiMoO₂), lithium tantalum oxide composite oxide (LiTaO₂), lithium tungsten oxide composite oxide (LiWO₂), lithium rich manganese nickel cobalt composite oxide (xLi₂MnO₃(1-x)LiMn_{1-y-z}Ni_{y}CO_{z}O₂), lithium nickel cobalt aluminum composite oxide (LiNi_{0.8}Co_{0.15}Al_{0.05}O₂), lithium nickel cobalt manganese composite oxide (LiNi_{0.33}Co_{0.33}Mn_{0.33}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, LiNi_{0.8}Co_{0.1}Mn_{0.1}O₂), and manganese nickel oxide (LiNi_{0.5}Mn_{1.5}O₄), but is not limited thereto.

As the conductive agent, carbon blacks such as carbon black, acetylene black, Ketjen black, channel black, furnace black, lamp black, and thermal black; conductive fibers such as carbon fibers and metal fibers; metal powders such as carbon fluoride, aluminum, and nickel powder; conductive whiskers such as zinc oxide and potassium titanate; conductive metal oxides such as titanium oxide; and conductive materials such as polyphenylene derivatives may be used, but are not particularly limited as long as they have conductivity without causing chemical change in the battery.

The binder polymer may include one or more selected from the group consisting of nitrile butadiene rubber, polyethylene glycol, polyacrylonitrile, polyvinyl chloride, polymethyl methacrylate, polypropylene oxide, polydimethylsiloxane, polyvinylidene fluoride, polyvinylidene carbonate, and polyvinylpyrrolidinone, and preferably, it may be one or more selected from the group consisting of polyvinylidene fluoride, polyvinylidene carbonate, and polyethylene glycol, but is not limited thereto.

The anode layer may include an anode current collector and an anode active material layer formed on the anode current collector.

Non-limiting examples of the anode current collector may be selected from foils manufactured by copper, gold, nickel, or copper alloy, or a combination thereof. The anode active material layer may include soft carbon, hard carbon, artificial graphite, natural graphite, expanded graphite, carbon fiber, non-graphitizable carbon, carbon black, carbon nanotube, acetylene black, Ketjen black, graphene, fullerene, activated carbon, and meso carbon microbeads; a metal selected from silicon, tin, lithium, aluminum, silver, bismuth, indium, germanium, lead, platinum, titanium, zinc, manganese, cadmium, cerium, copper, cobalt, nickel, and iron; an alloy including two or more of the metals; and an oxide of one or more of the metals; or one or more selected from the group consisting thereof, and preferably, it may be lithium metal, but is not limited thereto.

The all-solid-state battery may be manufactured in a shape commonly used in the related field, and there is no limitation on the external appearance depending on the use of the battery, and examples include cylindrical, prismatic, pouch-type, or coin-type using a can.

Hereinafter, embodiments of the present invention will be described in detail with reference to the attached drawings. However, this is provided only to enable a person skilled in the art to which the present invention belongs to easily carry out the invention, and the present invention can be embodied in various different forms, and the scope of the present invention is not necessarily thereto.

### Preparation Example 1

An ionic liquid (1,2-dimethoxyethane) and a lithium salt (LiFSI) were mixed in a molar ratio of 1:1, a polyfunctional monomer (ethoxylated trimethylolpropane triacrylate (ETPTA)) was added in an amount of 3.5 wt % based on the total weight, and a photoinitiator was added in an amount of 1 part by weight based on 100 parts by weight of the ETPTA to prepare a mixture.

Furthermore, in order to evaluate the physical properties of the gel polymer electrolyte (cross-linked polymer matrix, ionic liquid, and lithium salt), the prepared mixture was coated and UV cross-linking was performed by irradiating a 365 nm UV lamp for 1 minute to prepare a 70 μm gel polymer electrolyte film. As a result of measuring the Young's modulus of the gel polymer electrolyte film according to ASTM D882, it was found to be 30 MPa.

### Preparation Example 2

A mixture was prepared in the same manner as in Preparation Example 1, except that diethylene glycol dimethyl ether was used as the ionic liquid.

### Preparation Example 3

A mixture was prepared in the same manner as in Preparation Example 1, except that ETPTA was added in an amount of 5 wt %.

### Preparation Example 4

A mixture was prepared in the same manner as in Preparation Example 1, except that ETPTA was added in an amount of 10 wt %.

### Preparation Example 5

A mixture was prepared in the same manner as in Preparation Example 1, except that ETPTA was added in an amount of 15 wt %.

### Preparation Example 6

A mixture was prepared in the same manner as in Preparation Example 1, except that diethylene glycol diethyl ether was used instead of 1,2-dimethoxyethane.

### Preparation Example 7

A mixture was prepared in the same manner as in Preparation Example 1, except that triethylene glycol dimethyl ether was used instead of 1,2-dimethoxyethane.

### Preparation Example 8

A mixture was prepared in the same manner as in Preparation Example 1, except that tetraethylene glycol dimethyl ether was used instead of 1,2-dimethoxyethane.

### Preparation Example 9

A mixture was prepared in the same manner as in Preparation Example 1, except that diethylene glycol dimethyl ether (diglyme) was used instead of 1,2-dimethoxyethane, and LiTFSI was used instead of LiFSI.

### Preparation Example 10

A mixture was prepared in the same manner as in Preparation Example 1, except that triethylene glycol dimethyl ether was used instead of 1,2-dimethoxyethane, and LiTFSI was used instead of LiFSI.

### Preparation Example 11

A mixture was prepared in the same manner as in Preparation Example 1, except that tetraethylene glycol dimethyl ether was used instead of 1,2-dimethoxyethane, and LiTFSI was used instead of LiFSI.

### Comparative Preparation Example 1

A mixture was prepared in the same manner as in Preparation Example 1, except that the polyfunctional monomer was not added.

### Comparative Preparation Example 2

A mixture was prepared in the same manner as in Preparation Example 1, except that a 1:1 volume ratio mixed solvent of general solvents, dimethyl ether and 1,3-dioxolane (DOL), was used instead of the ionic liquid, 1,2-dimethoxyethane.

### [Evaluation Example 1] Ion Conductivity (σLi)

An ion conductivity measurement cell was manufactured by stacking the gel polymer electrolyte films prepared in the Preparation Examples between two identical stainless steel foils, and the ion conductivity was measured. Based on EIS (Electrochemical Impedance Spectroscopy) analysis, the impedance was measured by applying an AC amplitude of 10 mV in a frequency range of 0.1 mHz to 5 MHz at room temperature, and the ion conductivity was calculated according to Equation 1 below. The results are listed in Table 1 below. In addition, the ion conductivity of the liquid electrolyte alone mixed with the ionic liquid (1,2-dimethoxyethane) and the lithium salt (LiFSI) in a molar ratio of 1:1 was 2.64 mS/cm.

$${σ}_{Li} = \frac{l}{RS} \qquad [ Equation 1 ]$$

(In Equation 1, 1 is the thickness of the cell, R is the resistance measured through EIS analysis, and S is the active area of the electrode.)

Further, a slurry composition was prepared by mixing each mixture of Preparation Examples 1 to 5 with the sulfide-based solid electrolyte (LPSCl (Lithium phosphorus sulfur chloride) having an average particle diameter of 3 μm) in a volume ratio of 3:7. Further, in order to measure the ion conductivity of the slurry composition, the slurry composition was coated and UV cross-linking was performed by irradiating a 365 nm UV lamp for 1 minute to prepare an organic-inorganic composite electrolyte film of about 450 μm. Subsequently, the ion conductivity of the organic-inorganic composite electrolyte film was measured in the same manner as in Evaluation Example 1 described above and listed in Table 1 below.

TABLE 1

| | | | Organic-Inorganic |
|---|---|---|---|
| | Gel Polymer | Polymer | Composite |
| | Electrolyte Film | Electrolyte Film | Electrolyte Film |
| | Young's Modulus | Ion Conductivity | Ion Conductivity |
| | [MPa] | [mS/cm] | [mS/cm] |
| Prep. Ex. 1 | 30 | 0.71 | 0.714 |
| Prep. Ex. 2 | 30 | 0.63 | 0.672 |
| Prep. Ex. 3 | 50 | 0.69 | 0.603 |
| Prep. Ex. 4 | 130 | 0.68 | 0.564 |
| Prep. Ex. 5 | 220 | 0.67 | 0.184 |
| Prep. Ex. 6 | 42 | 0.69 | 0.692 |
| Prep. Ex. 7 | 49 | 0.55 | 0.642 |
| Prep. Ex. 8 | 53 | 0.48 | 0.523 |
| Prep. Ex. 9 | 34 | 0.62 | 0.675 |
| Prep. Ex. 10 | 46 | 0.56 | 0.593 |
| Prep. Ex. 11 | 51 | 0.44 | 0.516 |

As shown in Table 1 above, the gel polymer electrolyte films of Preparation Examples 1 to 11 exhibited excellent ion conductivity, and particularly, Preparation Example 1 exhibited outstanding ion conductivity.

However, the organic-inorganic composite electrolyte film according to Preparation Example 1 exhibited very high ion conductivity due to the easy formation of the continuous phase of the sulfide-based solid electrolyte, whereas the organic-inorganic composite electrolyte film according to Preparation Example 5 showed insufficient ion conductivity compared to Preparation Example 1 due to the difficulty in forming the continuous phase of the sulfide-based solid electrolyte.

Further, in the case of Comparative Preparation Example 2, which used a 1:1 volume ratio mixed solvent of general solvents, dimethyl ether (DME) and 1,3-dioxolane (DOL), instead of the ionic liquid in Preparation Example 1, it was confirmed that the mobility of the solvated lithium ions could decrease significantly, leading to a sharp decrease in ion conductivity. Furthermore, in the case of Preparation Examples 6-11, they exhibited somewhat insufficient ion conductivity compared to Preparation Example 1, but it was confirmed that the ion conductivity of the organic-inorganic composite electrolyte film was significantly improved compared not only to Comparative Preparation Examples 1 and 2, but also to Preparation Example 5.

### Example 1

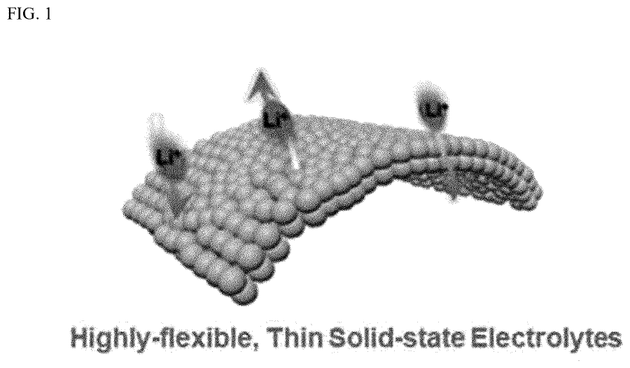

A slurry composition was prepared by mixing the mixture of Preparation Example 1 with the sulfide-based solid electrolyte (LPSCl (Lithium phosphorus sulfur chloride) having an average particle diameter of 3 μm) in a weight ratio of 4:6. The slurry composition was tape-cast on one side of an aromatic aramid porous support having a thickness of about 18 μm (average pore size: about 70 μm, porosity: about 86%), and the polyfunctional monomer was photocured to form an organic-inorganic composite electrolyte by irradiating a 365 nm UV lamp for 1 minute to perform UV cross-linking. Subsequently, the opposite side was also cast and photocured in the same manner, and then pressed at a pressure of 370 MPa to finally manufacture an organic-inorganic composite electrolyte membrane in which the organic-inorganic composite electrolyte and the porous support were integrated, having a thickness of 35 μm. A schematic diagram of the organic-inorganic composite electrolyte membrane according to Example 1 is shown in FIG. 1.

### Example 2

The procedure was carried out in the same manner as in Example 1, except that the mixture of Preparation Example 5 was used instead of the mixture of Preparation Example 1.

### Comparative Example 1

A slurry composition was prepared by mixing the mixture of Comparative Preparation

Example 1 with the sulfide-based solid electrolyte (LPSCl (Lithium phosphorus sulfur chloride) having an average particle diameter of 3 μm) in a weight ratio of 4:6. The slurry composition was pressed at a pressure of 370 MPa to finally manufacture a solid electrolyte having a thickness of 300 μm. In the case of Comparative Example 1, thin film manufacturing was impossible unlike the Examples, and thus a thick film was manufactured. As a result of measuring the ion conductivity of the solid electrolyte according to Comparative Example 1, it was found to be 1.42×10⁻³ S/cm.

### [Evaluation Example 2] 180° Bending Test

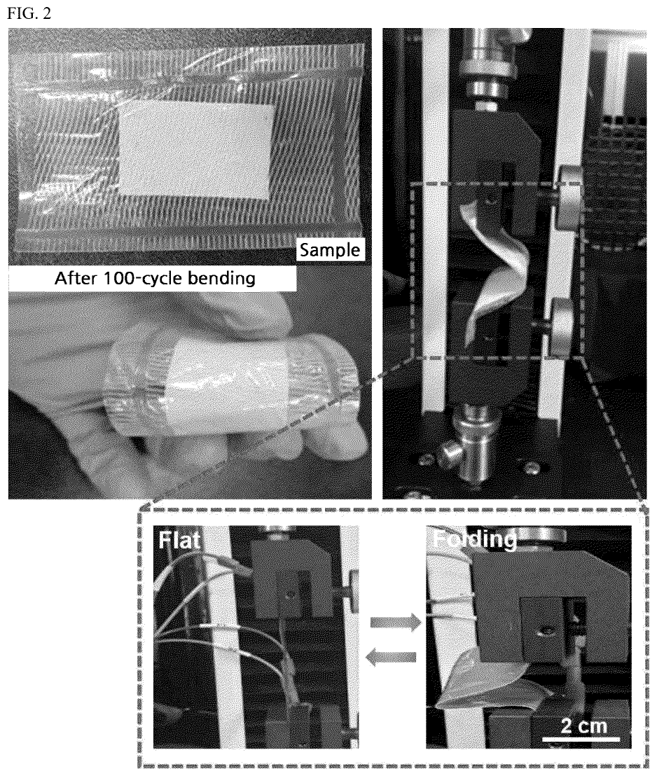

To evaluate the flexibility of the organic-inorganic composite electrolyte membranes prepared in Examples 1, 2, and Comparative Example 1, a 180° bending test was performed. Specifically, a 90 mm×80 mm sample was prepared with the organic-inorganic composite electrolyte membrane placed in the center. The ends of this sample were secured to the head of a UTM (Universal Testing Machine) so that they interlocked by 20 mm each, and the test of bending and unbending the sample 180° was repeated for 100 cycles under a speed condition of 200 mm/min. The approximate experimental method is shown in FIG. 2. (Note: FIG. 2 illustrates the 180° bending test process.)

$$Ion conductivity retention rate after 100 cycles of bending test = ( Ion conductivity after 100 cycles of 180 ° bending test / Intitally measured ion conductivity ) \times 100$$

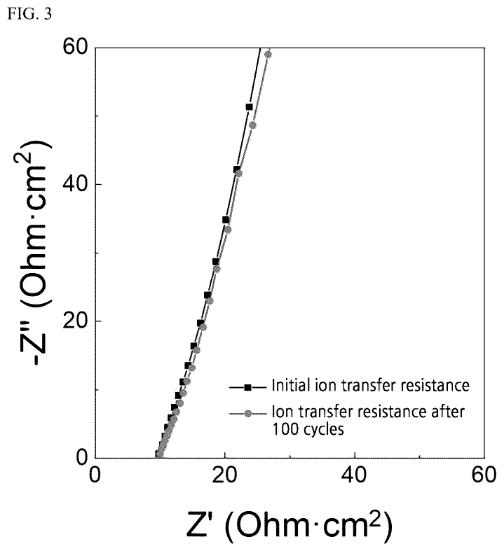

It was confirmed that the organic-inorganic composite electrolyte membrane according to Example 1 maintained 99% compared to the initially measured ion conductivity (0.4 mS/cm) after 100 cycles of the 180° bending test. Furthermore, the Nyquist plot analyzed by electrochemical impedance spectroscopy (EIS) using Bio-Logic VSP-Classic analyzer for the organic-inorganic composite electrolyte membrane according to Example 1 before and after 100 cycles of the 180° bending test is shown in FIG. 3, which confirms that Example 1 exhibited a charge transfer resistance equivalent or similar to the initial ion transfer resistance (charge transfer resistance) without rapid degradation even after 100 cycles of the 180° bending test.

However, in the case of Comparative Example 1, it was difficult to manufacture a free-standing film, and the electrolyte membrane fractured even with a single bend, making physical property measurement impossible.

Further, since Example 2 used a gel polymer electrolyte having a high Young's modulus, it showed insufficient initial ion conductivity (0.14 mS/cm) or ion conductivity retention rate after 100 cycles of the bending test compared to Example 1. Specifically, Example 1 allows the continuous phase between the inorganic particles, which are the sulfide-based solid electrolyte, to be smoothly formed, and thereby lithium ions move through the continuous phase of the inorganic particles, thereby realizing excellent ion conductivity, whereas Example 2 was analyzed to exhibit more insufficient physical properties because the continuous phase between the inorganic particles was not formed, making it difficult to secure a path for lithium ion movement.

### [Evaluation Example 3] Lithium Ion Migration Evaluation

Furthermore, the organic-inorganic composite electrolyte membranes (using 7Li) prepared in Examples 1 and 2 were stacked between two identical lithium metal (6Li) foils to manufacture a symmetric cell (6Li∥ Organic-Inorganic Composite Electrolyte Membrane (7Li)∥ 6Li). The lithium ion transference number (tLi+) was evaluated using the Bruce-Vincent analysis method (potentiostatic polarization method) on the symmetric cell.

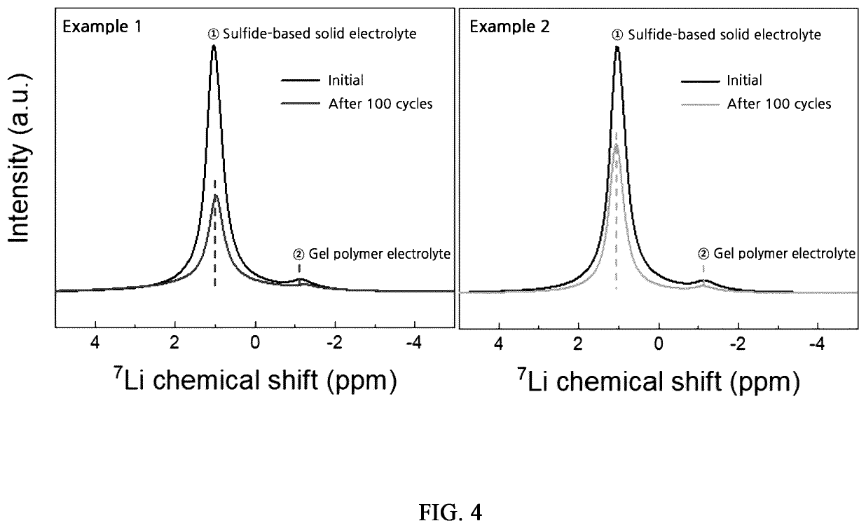

Further, before and after 100 cycles of the 180° bending test, the organic-inorganic composite electrolyte membrane of the symmetric cell was analyzed by 7Li MAS NMR in the same manner as in Evaluation Example 1, and the resulting spectrum is shown in FIG. 4. Through FIG. 4, the path of dominant migration of the organic-inorganic composite electrolyte that had 7Li after exchange with 6Li toward either the sulfide-based solid electrolyte or the gel polymer electrolyte can be identified.

Referring to FIG. 4, in the case of Example 1, the ratio of the peak intensity of sulfide-based solid electrolyte \textcircled{1}/gel polymer electrolyte \textcircled{2} decreased from 9.96 to 5.26 after 100 cycles, which showed that lithium ions dominantly moved via the sulfide-based solid electrolyte path, indicating that the continuous phase formation of the sulfide-based solid electrolyte particles was good, and the lithium ion transference number also showed a high value of 0.69.

On the other hand, in the case of Example 2, the ratio of the peak intensity of sulfide-based solid electrolyte \textcircled{1}/gel polymer electrolyte \textcircled{2} was measured to increase or be similar from 8.72 to 8.85, which indicates that the migration of lithium ions was dominated by movement toward the gel polymer electrolyte, and the lithium ion transference number showed a low value of 0.37.

### Manufacturing of All-Solid-State Lithium Metal Battery

A cathode slurry composition was prepared by adding components to N-methylpyrrolidone such that the cathode material content was 40 wt %, based on the following weight ratio (w/w/w/w)): Cathode Active Material (LiNi_{0.7}Co_{0.15}Mn_{0.15}O₂ (NCM711) coated with LiNbO₃ (1.4 wt. %))/Solid Electrolyte (LPSCl)/Binder (polybutadiene rubber)/Conductive Agent (carbon black; Super C65)=74.5/21.5/2.0/2.0. The cathode slurry composition was coated onto a 10 μm-thick Aluminum (Al) thin film using a doctor blade, hot-air dried at 80° C., followed by vacuum drying at 120° C. for 24 hours, thereby forming a cathode active material layer 110 μm thick

Thereafter, the aromatic aramid porous support of Example 1 was placed on the cathode active material layer, and the slurry composition of Example 1 was impregnated into the porous support and the cathode active material layer, and a pressure of 370 MPa (~ 5 ton) was applied at room temperature for 2 minutes using a hydraulic press (Hefei Kejing Materials Technology Co., Ltd.) to form a film.

The film was irradiated with a 365 nm UV lamp for 1 minute to manufacture a cathode layer impregnated with the organic-inorganic composite electrolyte and a 40 μm thick solid electrolyte layer integrated with the cathode layer.

Thereafter, a graphite anode was manufactured from an anode active material composition included in a weight ratio of Anode active material (Graphite/solid electrolyte (LPSCl)/binder (polybutadiene rubber)/conductive agent (carbon black; Super C65)) of 75.0/22.0/3.0/0.0 (w/w/w/w), and then an anode layer, in which the 106 μm thick graphite anode was rolled onto a 9 μm thick copper foil current collector, was stacked to manufacture an all-solid-state lithium metal battery.

### [Evaluation Example 4] Evaluation of Life Characteristics and Rate Characteristics

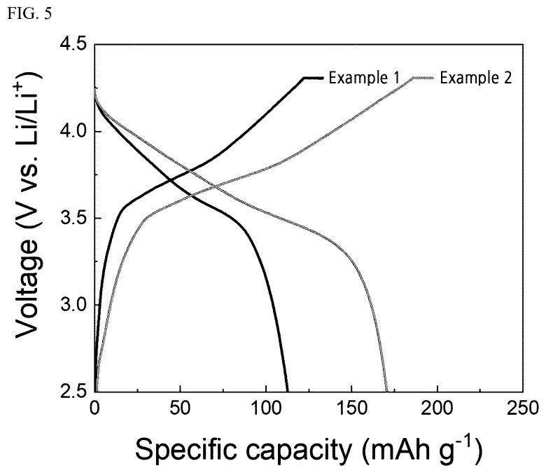

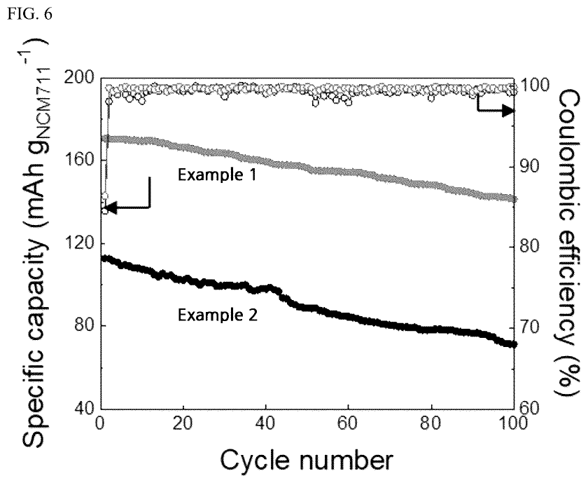

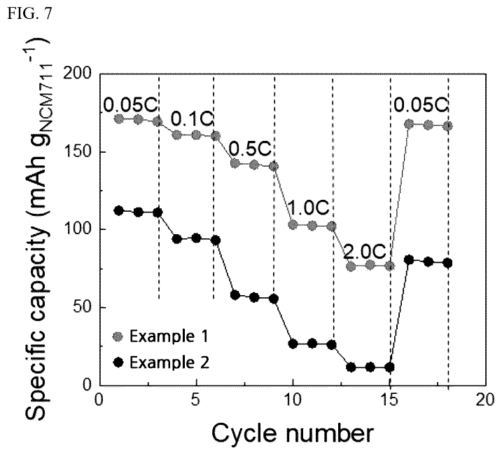

The room temperature life characteristics and rate characteristics of the manufactured all-solid-state battery were analyzed. The charge/discharge conditions involved conducting a 100-cycle life test at room temperature (25° C.) at a current density of 0.05 C(=0.088 mA/cm²) in a voltage range of 2.5 to 4.3 V, and the results are shown in FIGS. 5 and 6. Further, to measure the rate characteristics, several cycle tests were performed by changing the current density from 0.05 C(=0.088 mA/cm²) to 2.0 C(=3.2 mA/cm²) in a voltage range of 2.5 to 4.3 V, and the results are shown in FIG. 7.

Referring to FIGS. 5 to 7, the all-solid-state lithium metal battery applied with the organic-inorganic composite electrolyte membrane of Example 1 exhibits excellent initial charge/discharge capacity and realizes an excellent capacity retention rate of 80% or more even after 100 cycles. Specifically, when the Young's modulus of the organic-inorganic composite electrolyte satisfies 5 to 100 MPa, or 5 to 40 MPa, the connectivity between the inorganic particles is not hindered, allowing the inorganic particles to form a continuous phase, and thus exhibiting superior ion conductivity than the organic-inorganic composite electrolyte of Example 2, which has a high Young's modulus.

Accordingly, the organic-inorganic composite electrolyte membrane according to one aspect of the present invention can be manufactured as a thin film, exhibits excellent flexibility, has high ion conductivity operable at room temperature, and has excellent interfacial stability with high-capacity cathode materials or graphite anodes, thereby showing outstanding life characteristics and rate characteristics.

As described above, the present invention has been described by way of limited embodiments, but this is merely provided to help a more comprehensive understanding of the present invention, and the present invention is not limited to the above embodiments, and a person having ordinary skill in the art to which the present invention belongs may make various modifications and variations from this description.

Therefore, the spirit of the present invention should not be limited to the described embodiments, and everything that is equivalent to or has equivalent modifications to the following claims, as well as the claims themselves, shall fall within the scope of the spirit of the present invention.

What is claimed is:

1. An organic-inorganic composite electrolyte membrane comprising a porous support and an organic-inorganic composite electrolyte,
wherein the organic-inorganic composite electrolyte includes a sulfide-based solid electrolyte, a cross-linked polymer matrix, an ionic liquid, and a lithium salt, and the organic-inorganic composite electrolyte is integrated with the porous support.

2. The organic-inorganic composite electrolyte membrane of claim 1, wherein the ionic liquid includes a glyme-based solvent.

3. The organic-inorganic composite electrolyte membrane of claim 1, wherein the molar ratio of the ionic liquid to the lithium salt satisfies 0.5 to 1.5:1.

4. The organic-inorganic composite electrolyte membrane of claim 1, wherein the cross-linked polymer matrix is derived from a polyfunctional monomer.

5. The organic-inorganic composite electrolyte membrane of claim 4, wherein the polyfunctional monomer is a monomer containing two or more photocurable functional groups selected from the group consisting of an acrylate group, a methacrylate group, a vinyl group, and a thiol group, or one or more thereof.

6. The organic-inorganic composite electrolyte membrane of claim 1, wherein the weight ratio of the cross-linked polymer matrix to the sum of the ionic liquid and the lithium salt satisfies 3 to 15:85 to 97.

7. The organic-inorganic composite electrolyte membrane of claim 1, wherein the cross-linked polymer matrix is included in an amount of 0.5 to 10 parts by weight based on 100 parts by weight of the sulfide-based solid electrolyte.

8. The organic-inorganic composite electrolyte membrane of claim 1, wherein the porous support has an average pore size of 50 μm or more.

9. The organic-inorganic composite electrolyte membrane of claim 8, wherein the porous support has a thickness of 5 to 40 μm.

10. The organic-inorganic composite electrolyte membrane of claim 1, wherein the thickness is 10 to 40 μm.

11. The organic-inorganic composite electrolyte membrane of claim 1, wherein the ion conductivity is 3.0×10⁻⁴ S/cm or more.

12. The organic-inorganic composite electrolyte membrane of claim 1, wherein the ion conductivity retention rate after 100 cycles of the 180° bending test is 90% or more.

13. The organic-inorganic composite electrolyte membrane of claim 1, wherein the organic-inorganic composite electrolyte membrane has a structure in which two or more layers are stacked in the thickness direction.

14. A method for manufacturing an organic-inorganic composite electrolyte membrane, comprising a step of manufacturing an organic-inorganic composite electrolyte by coating and polymerizing a slurry composition including a sulfide-based solid electrolyte, a polyfunctional monomer, an ionic liquid, and a lithium salt on a porous support.

15. The method for manufacturing an organic-inorganic composite electrolyte membrane of claim 14, wherein the ionic liquid includes a glyme-based solvent.

16. The method for manufacturing an organic-inorganic composite electrolyte membrane of claim 14, wherein the slurry composition substantially does not include a solvent.

17. The method for manufacturing an organic-inorganic composite electrolyte membrane of claim 14, further comprising a step of pressing the organic-inorganic composite electrolyte membrane.
